(19) United States
(12) Patent Application Publication
(10) Pub. No.: US 2024/0344860 A1
(43) Pub. Date: Oct. 17, 2024

(54) Method for Flow Measurement Subject to Interference, Magneto-Inductive Flow Meter and Computer Program Product

(71) Applicant: Siemens Aktiengesellschaft, Muenchen (DE)

(72) Inventors: Wilko WILKENING, Erlangen (DE); Mohamed NAIT MEZIANE, Bischheim (FR)

(21) Appl. No.: 18/294,681

(22) PCT Filed: Jul. 7, 2022
(86) PCT No.: PCT/EP2022/068953

§ 371 Date: Feb. 2, 2024

(30) Foreign Application Priority Data
Aug. 6, 2021 (DE) 10 2021 208 598.9

(51) Int. Cl. G01F 1/60

(52) U.S. Cl. CPC G01F 1/60

(57) ABSTRACT

A method for measuring a flow in a pipe via a magneto-inductive flowmeter, wherein a magnet coil of the magneto-inductive flowmeter is excited with a square-wave signal at a pulse frequency and a measurement signal is detected, a first measured value portion of the measurement signal, which comprises a first and a second sub-portion, is measured, a respective average value of the measurement signal is determined in the first and second sub-portions, and interference in the measurement signal is detected based on the respective average value if the average values differ from one another by at least one adjustable interference threshold value, where the invention also relates to a magneto-inductive flowmeter having a control unit configured to use a computer program product, a computer program product formed as a digital twin and configured to simulate the operating response of a flowmeter.

### CROSS-REFERENCE TO RELATED APPLICATIONS

This is a U.S. national stage of application No. PCT/EP2022/068953 filed 7 Jul. 2022. Priority is claimed on German Application No. 10 2021 208 598.9 filed 6 Aug. 2021, the content of which is incorporated herein by reference in its entirety.

### BACKGROUND OF THE INVENTION

### 1. Field of the Invention

The invention relates to methods for measuring a flow rate in a pipe via an inductive magnetic flowmeter, a computer program product for performing at least one such method, a control unit including the computer program product and a correspondingly equipped magneto-inductive flowmeter, and to a computer program product for simulating an operating behavior of such a magneto-inductive flowmeter.

### 2. Detailed Description of the Related Art

DE 102 56 103 A1 discloses a method for determining the uncertainty of a measuring method processed with a measuring frequency that is usable in magneto-inductive flowmeters. Here, alternating square-wave pulses are excited and from each of these, time intervals are evaluated. For evaluation, a transient condition is firstly processed.

DE 10 2019 103 501 A1 discloses a method for operating a magneto-inductive flow measuring device in which gas bubbles are detected in a measuring pipe. Square wave pulses are generated and evaluated to establish a flow velocity in the measuring pipe. In pauses between square wave pulses, a measurement signal is sampled multiple times and a mean value is formed from the measurement signals captured per pause time. Differences between a plurality of mean values of a plurality of periods are formed and these are compared with a threshold value. In the case of a filled measuring pipe, the differences are approximately zero.

Published unexamined patent application DE 10 2004 031 638 A1 discloses a method for operating a magneto-inductive flow measurement facility in which interference signals are minimized. Here, from a received signal spectrum that includes interference signals, and from a reference voltage, a vector product is formed. Starting therefrom, via an inverse Fourier transform, a useful signal component is established on the basis of which a flow rate is calculated.

U.S. Pat. No. 6,615,149 B1 discloses a method for spectral diagnostics on a magnetic flowmeter in which a flow measurement that is subject to interference occurs. With a Fourier analysis, an interference in the region of a mains frequency of 50 Hz or 60 Hz is established and, if relevant, a warning is output to a user.

Flowmeters are utilized in a large number of applications, for example, chemical engineering plants, in order to determine throughput rates of liquids or gases. The flowmeters are therein often subject to interference influences, as a result of which a measuring accuracy of the flowmeter can be reduced. At the same time, cost-effective flowmeters are striven for. There is therefore a need for flowmeters that are robust against interference influences, permit precise measurements and at the same time are also cost-effective to manufacture.

### SUMMARY OF THE INVENTION

It is an object of the invention to provide methods for measuring a flow rate in a pipe via an inductive magnetic flowmeter, a computer program product for performing at least one such method, a control unit including the computer program product and a correspondingly equipped magneto-inductive flowmeter that make it possible to offer an improvement in at least one of the aspects outlined.

These and other objects and advantages are achieved in accordance with the invention by a method via which a flow rate of a fluid in a pipe is measured. For this purpose, a magneto-inductive flowmeter is used that is fastened to the pipe. The magneto-inductive flowmeter has a magnet coil via which a magnetic field can be induced in the cross-section of the pipe, where the field enters into interaction with charged particles flowing in the pipe. In this way, an electric voltage can be elicited in the cross-section of the pipe perpendicularly in the magnetic field, where the voltage can be captured via suitably attached voltage sensors. In a first step of the method, an excitation of the magnet coil with a square-wave signal that has a pulse frequency occurs. The square-wave signal, also called a boxcar signal, can therein be generated from an overlaying of a plurality of sine wave signals. With the square-wave signal, an electric voltage is elicited in the cross-section of the pipe, which is captured as a measurement signal. The measurement signal also has a substantially square-wave shape. An amplitude of the measurement signal corresponds to the flow rate that is to be measured in the pipe. The method comprises a second step in which a capture of a first measurement value portion of the measurement signal occurs. The measurement value portion is a portion of the measurement signal in which, at least temporarily, the amplitude, i.e., the amplitude value, decreases. The amplitude itself depends upon a flow velocity in the pipe, i.e., upon the flow rate. The first measurement value portion comprises a first and second sub-portion that can be observed and evaluated separately. In particular, the measurement signal for the first and second sub-portion can be further processed separately.

The method further comprises a third step in which a mean value of the measurement signal is formed for each of the first and second sub-portions of the first measurement value portion. In particular, a mean amplitude value of the measurement signal can be formed across the first and/or second sub-portion as the mean value. Given an interference-free measurement signal, this assumes a constant amplitude value across the first and second sub-portions in the first measurement value portion. A difference between the mean values in the first and second sub-portions with the same length consequently becomes substantially zero. However, in the presence of an interference of corresponding frequency and phase, the mean values in the first and second sub-portions differ so that a difference between them deviates from zero. If the mean values in the first and second sub-portions deviate from one another by at least one settable interference threshold value, in the method in accordance with the invention, the presence of an interference is recognized. The interference threshold value can be specified, for example, by way of an input by a user or by an algorithm, so that the sensitivity of such an interference recognition is suitably adaptable to the respective existing application. If the existence of an interference is recognized, then the evaluation of the measurement signal can be adapted in order to thus measure the flow rate in the pipe precisely. The formation of a mean value for parts of a measurement signal, i.e., measurement value portions and their sub-regions, is possible with reduced computational effort. In an additional step, a displacement of the sub-portions occurs so that, for example, the first and the last 25% of the measurement value portion belong to the first sub-portion and the middle 50% of the measurement value portion belongs to the second sub-portion. Thereafter, the difference between the mean values of the sub-portions is formed anew.

The steps described implement a quadrature demodulation with a square-wave-shaped signal and subsequent low pass filtration, where the differences can be interpreted as real and imaginary parts of the demodulated signal. The value of the complex value then corresponds to the amplitude value of the interference signal. The evaluation can be continued over a plurality of periods of the excitation signal. A frequency selectivity of the interference detection is provided via the selection of the sub-portions.

The method in accordance with the invention can be implemented rapidly based on the mean value and difference formations, including on simple hardware. The presence of an interference in the measurement signal is also recognizable in a simple manner with a surprisingly high level of reliability. With suitable compensation measures, a corrected amplitude value can be established, which represents a precise measure for the existing flow rate in the pipe.

In one embodiment of the method, the first and the second sub-portion follow one another and therefore lie temporally one after the other. Therein, the second sub-portion can follow the first sub-portion directly or a temporal spacing can lie between them. Alternatively, the first and the second sub-portion can also partially overlap temporally. For example, the first sub-portion can begin together with the first measurement value portion and end after 50% of its total duration. In addition thereto, the second sub-portion can, for example, begin only after 25% of the total duration of the measurement value portion and end after completion of 75% of the total duration of the measurement value portion. Further alternatively or additionally, the first measurement value portion can also have further sub-portions, i.e., a third, fourth, etc. sub-portion. With the formation of mean values from just two sub-portions, the existence of an interference in the measurement value portion is recognizable in a simple manner. The mean values of shorter sub-portions can be further used to form the mean values of longer or differently positioned sub-portions. With this, interferences of different frequency and phase can be detected with little computational effort.

Furthermore, for the first measurement value portion and a second measurement value portion, a mean value of the measurement signal can be formed. The mean value is herein formed via the entire first and/or second measurement value portion. The first and second measurement value portion can be sequential measurement value portions in the measurement signal. Accordingly, the first and second measurement value portion can have opposite amplitudes. For example, via a suitable difference formation between the mean values in the first and second measurement value portion, quantitatively substantially double the amplitude of the measurement signal, i.e., double the amplitude value can be established. With a reduced computation effort, this provides a precise value for the amplitude of the measurement signal.

If, alternatively, rather than the difference formation, a summation of the mean values occurs, then with measurement value portions of identical temporal length, a very small value is to be expected. Given different temporal lengths, a corresponding weighting is to be undertaken. If a very small value does not result from the summation, then this is an indication of a disturbance, for example, a deviation of the magnetic fluxes from the nominal value or an electrochemical reaction at the electrodes. This can point to a defect or a degradation of a component of the magneto-inductive flowmeter.

In a further embodiment of the method, the first and second steps are also correspondingly implemented for the second measurement value portion. As a result, the measurement signal is captured separately for the first and second measurement value portion and can be further used. A characteristic variable of a measurement value portion, for example, the mean value of the measurement signal, is modulated as a time series onto a carrier signal, for example, via a quadrature amplitude modulation. The carrier signal has a carrier frequency that substantially corresponds to the pulse frequency with which the magnet coil is excited. From this, a frequency shift relative to a comparison frequency can be established. In particular, via a combination with the comparison frequency, in a frequency analysis, a spike results, i.e., a quantitative maximum, also referred to as a peak, at approximately 0 Hz if the measurement signal is interference-free. The combination can be configured, inter alia, as an “aliasing”. In the presence of an interference that affects the measurement signal, in the frequency analysis outlined, there results a peak at a frequency that corresponds to a frequency shift between the pulse frequency and the comparison frequency. With this, it is possible to discern whether the pulse frequency corresponds to a target value. For example, at a pulse frequency that is coupled to a mains frequency, it is possible to discern whether the existing mains frequency, if an interference linked thereto exists, corresponds to a mains target frequency, in particular 50 Hz or 60 Hz. The interference that occurs when the flow rate in the pipe is measured can thus be characterized more exactly and so can be specifically compensated for. Furthermore, the steps described can also be performed for a third, fourth etc. measurement value portion.

Furthermore, the square-wave signal with which the magnet coil is excited can have an inactive phase that is independent of the first and/or second measurement value portion. The inactive phase lies between two measurement value portions and substantially determines the temporal spacing with which amplitude values of the measurement signal can be generated. During the inactive phase, a re-poling of the generated magnetic field takes place. If, in the claimed method, an interference that is aperiodic is discerned, then the inactive phase is adjustable such that a sought-after sampling rate is achieved. The magneto-inductive flowmeter is thus adaptable, for example, to a further evaluating unit that further processes the measurement results of the magneto-inductive flowmeter are further processed. Alternatively or additionally, the inactive phase can be shortened thereby to achieve a raised sampling rate. Overall, the technical potential of the magneto-inductive flowmeter is thereby further exhausted. In particular, via a reduction of the inactive phase to the duration that is required for pole reversal of the magnetic field, a limit is set for the technical potential of the magneto-inductive flowmeter which, however, is entirely usable by the claimed solution.

Furthermore, the method can comprise a further step in which a pulse duration of the square-wave signal, i.e., substantially the total duration of the respective measurement value portions and/or the duration of the inactive phase are adapted, i.e., modified. The adaptation occurs for a balancing of an interference effect in successive measurement value portions. With such an adaptation of the pulse duration and/or the duration of the inactive phase, the effects of the interference on the measurement signal, for example, on establishment of a doubled amplitude value as set out above by way of example, can be mutually equalized. With this, in particular, the effect of an interference that is periodic, i.e., which is coupled, for example, to the pulse frequency can be reduced. The computational effort for the compensation of the interference and/or its interference effect is thereby further reduced, which provides the method with an increased level of robustness and with a simultaneously broad spectrum of use. The aforementioned equalization can also occur over more than two measurement value portions. This can be necessary if the interference signal has a low frequency. An amplitude value formed after two measurement value portions would then still be fault-laden. The averaging of a plurality of amplitude values, for example, two or four amplitude values then leads to the equalization of the interference.

In a further embodiment of the method, in an additional step, an excitation of the magnet coil can be interrupted for an adjustable duration. This can consist of an omission of at least one pulse or can occur in a period between two excitations of the magnet coil. During this, detection of a residual magnetic field remaining in the pipe occurs, which is further evaluated. In an intended state, if the excitation of the magnet coils is omitted, then no technically usable or evaluable measurement signal is to be expected. In an interference-affected stage, the measurement signals received correspond to an interference which is evoked, for example, by a magnetic field of a nearby electric device. Such detected interferences are ignored and/or suppressed in a further operation of the magneto-inductive measuring apparatus when the measurement signals are evaluated. Also, via the evaluation of the measurement signals of the residual magnetic field, an interference cause can be diagnosed, for example, an electromagnetic coupling onto turns of the magnet coil. In total, a further rise in the measurement accuracy and differentiated self-diagnosis of the magneto-inductive flowmeter is achievable.

The underlying problem addressed is also solved with the following method in accordance with the invention. This rests upon the same mathematical and signal theory basis as the above-described embodiments of the method. The above-described embodiments of the method and the method described below therefore represent different facets of the same technological concept and are linked to the same considerations and discoveries that are essential to the invention.

The method in accordance with the invention serves for measuring a flow rate of a liquid in a pipe to which a magneto-inductive flowmeter is fastened. The magneto-inductive flowmeter has a magnet coil via which a magnetic field can be induced in the cross-section of the pipe, where the field enters into interaction with charged particles flowing in the pipe. With this, an electric voltage can be elicited in the cross-section of the pipe perpendicularly in the magnetic field, where the voltage can be captured via suitably attached voltage sensors. In a first step of the method, an excitation of the magnet coil with a square-wave signal which has a pulse frequency occurs. The square-wave signal, also called a boxcar signal, can therein be generated from an overlaying of a plurality of sine wave signals. With the square-wave signal, an electric voltage is elicited in the cross-section of the pipe, which is captured as a measurement signal. The measurement signal also has a substantially square-wave shape. An amplitude of the measurement signal corresponds to the flow rate that is to be measured in the pipe.

The method also comprises a second step in which a frequency analysis of the measurement signal is performed. The frequency analysis can therein be performed during the run time of the method, proceeding in parallel. The frequency analysis can analyze the measurement signal in the form of a time-frequency analysis across time portions which can overlap one another. With the frequency analysis in the second step, an establishment of frequency components of the measurement signal occurs. Proceeding therefrom, the frequency components are examined more closely. In a third step, a frequency component is recognized as a square-wave frequency component, i.e., as induced via the square-wave signal in the magnet coil when the corresponding frequency component corresponds to an odd-numbered multiple of the pulse frequency. Underlying the invention, inter alia, is the recognition that a square-wave signal is formed as a combination of oscillations, the frequencies of which correspond, for example, to a single, three-fold, five-fold, seven-fold, etc., multiple of the pulse frequency. An interference-free measurement signal therefore shows, in the frequency analysis, exclusively the frequency components outlined above with predictable amplitudes and phases. Furthermore, via a combination of two overlaid square-wave signals, inactive phases can be defined between their measurement value portions. If a frequency component of the measurement signals is not a square-wave frequency component, then a fourth step occurs in the method in accordance with the invention. Therein, the corresponding frequency component of the measurement signal is recognized as an interference frequency. With the method in accordance with the invention, interference frequencies are recognizable not only qualitatively, but also quantitatively at the same time. This enables, via suitable filtration or correction measures, the interference effect that arises from the interference frequency, to be equalized. Frequency analyses can be performed rapidly and enable a precise evaluation of the measurement signal. In such a frequency analysis of the measurement signal, amplitude values and phase values thereof can be established algebraically, which enables an exact evaluation of the measurement signal. Accordingly, the method in accordance with the invention is suitable for establishing the amplitude value in the measurement value portion precisely, which enables an exact calculation of the flow rate in the pipe despite an existing interference. In addition, the method in accordance with the invention is suitable, in the process of the frequency analysis of the measurement signal, to recognize a defect or a degradation of components of the magneto-inductive flowmeter, because the degradation has the result that the result of the frequency analysis deviates from the expected result. The method in accordance with the invention is further suitable for identifying different interferences and consequently has a heightened level of robustness. The technical potential of the magneto-inductive flowmeter used is thereby further exploited. A square-wave signal should also be understood to be any signal that has a predictable result in a frequency analysis in which the effects of interferences and degradations emerge clearly identifiably.

In accordance with the invention, the method comprises a further step in which the duration of the measurement value portions is set to a whole-number multiple of the period duration of an interference signal. For this purpose, in accordance with the invention, the durations of inactive phases are adapted. In addition, the pulse frequency can be adapted.

In one embodiment of the method, the frequency analysis is implemented as a Fourier analysis or a wavelet analysis. These provide precise information regarding the properties of the measurement signal as a whole and regarding selectable portions of the measurement signal, in particular the measurement value portions that could be subject to an interference effect. Furthermore, Fourier analyses and/or wavelet analyses are provided in a large number of signal processing chips or controllers as efficiently implemented functions. In this way, the technical potential of magneto-inductive flowmeters is also more fully utilized. In addition, the method in accordance with the disclosed embodiments can also be implemented retrospectively on existing magneto-inductive flowmeters in the context of a software or firmware update. Accordingly, the technically useful working life of existing magneto-inductive flowmeters can be prolonged cost-effectively. Further alternatively, in place of a frequency analysis, a “least squares” estimate can also be implemented, which can be implemented rapidly with few measurement signals.

Furthermore, in the disclosed embodiments of the method, in a fifth step, an amplitude, i.e., an amplitude value of the measurement signal, can be established at least in a measurement value portion based on the frequency analysis. For example, in a Fourier analyzed measurement signal, the amplitude corresponds to the sum of the harmonic oscillations with alternating sign. A sum of this type can be rapidly established with a reduced computation effort. With this, intermediate results are made further use of in the frequency analysis, so that the disclosed embodiments of the method can be implemented rapidly. In particular, based on the algebraic calculation capability of the amplitude value, additional computation steps, such as mean value formations, are dispensable.

In a further embodiment of the method, the further step in which the duration of the measurement value portions is set to a whole-number multiple of the period duration of an interference signal includes that the pulse frequency is adapted.

In embodiments in which mean values are formed via measurement value portions, periodic interferences of corresponding period duration are suppressed in this way. With corresponding adaptation, simultaneously two interferences of different and non-harmonically related frequency can be suppressed.

The objects and advantages in accordance with the invention are equally achieved by a computer program product in accordance with the invention which is provided for driving a magnet coil and for processing measurement signals of a voltage sensor. For this purpose, the computer program product has suitable interfaces that enable a corresponding input and output of data and/or commands. The magnet coils and the voltage sensor therein belong at least functionally to a magneto-inductive flowmeter. The computer program product is further provided to establish, i.e., measure, a flow rate of a fluid in the cross-section of a pipe upon which the flowmeter is fastened. For this purpose, the computer program product is configured, in accordance with the invention, to implement at least one embodiment of the disclosed embodiments of the method. The computer program product can be implemented on a computer unit that cooperates with a storage unit. Furthermore, the computer program product can be formed in a monolithic manner, i.e., it can implement all its functions on one hardware platform. Alternatively, the computer program product can also be formed as a system of at least two partial programs that can be executed on different hardware platforms and can cooperate via a communicative data connection. Each partial program therein comprises at least one function of the computer program product, for example, a specification of parameter values for the magneto-inductive flowmeter. The functioning of the computer program product is realized via this cooperation. Such partial programs can be performed, for example, on a control unit of the magneto-inductive flowmeter, a master computer and/or a computer cloud. In addition, the computer program product can be formed purely as software or hard-wired, for example, as a chip, integrated circuit or FPGA. Further alternatively, the computer program product can also be formed as a combination thereof.

The objects and advantages in accordance with the invention are equally achieved via a control unit in accordance with the invention. The control unit comprises a storage unit and a computer unit that cooperate during operation and permit the execution of computer program products. The control unit is configured to drive a magneto-inductive flowmeter and, for this purpose, has suitable inputs and outputs for data and/or commands. In accordance with the invention, the control unit is configured to implement a computer program product that is configured in accordance with the above-disclosed embodiments. Alternatively, the control unit can be configured to implement at least one embodiment of the abode-disclosed embodiments of the method. A control unit of this type can be realized with simple hardware and is therefore particularly cost-effective. The technical advantages of the underlying methods are thus achievable to a particularly high degree.

The objects and advantages in accordance with the invention are equally achieved via a magneto-inductive flowmeter in accordance with the invention. The magneto-inductive flowmeter is configured to measure a flow rate of a fluid in a cross-section of a pipe and, for this purpose, has a magnet coil and a voltage sensor. The magnet coil and the voltage sensor can be actuated and/or read via a control unit. In accordance with the invention, the control unit is configured in accordance with an embodiment of the above-disclosed embodiments.

The objects and advantages in accordance with the invention are furthermore achieved by a computer program product in accordance with the invention which is suitable for a simulation of an operating behavior of a magneto-inductive flowmeter, and in particular is configured therefor.

In particular, the computer program product can be configured to simulate the operating behavior of the magneto-inductive flowmeter in that its design is firmly defined therein, i.e., a mapping thereof is stored. Alternatively, the operating behavior can also be represented via an abstracted computation model that is independent of the spatial construction of the magneto-inductive flowmeter. Further alternatively, the operating behavior can also be established based on a combination thereof. The magneto-inductive flowmeter to be simulated is configured, in accordance with the invention, in accordance with one embodiment of the above-disclosed embodiments. The computer program product can have a physics module for simulation in which the magneto-inductive flowmeter is mapped and, for example, its electrical or signaling behavior can be emulated under adjustable operating conditions. For example, the adjustable operating conditions include a flow rate in the cross-section of the pipe, a temperature, a pressure, a viscosity in the fluid in the pipe, its conductivity, its induction behavior, magnetic permeability, a magnetizing capacity or an interference spectrum with different interference frequencies. For this purpose, the computer program product can have a data interface via which corresponding data can be specified through a user input and/or other simulation-directed computer program products. The computer program product can also have a data interface for the output of simulation results to a user and/or other simulation-directed computer program products. With the computer program product, for example, measurement signals of voltage sensors of the magneto-inductive flowmeter or other sensor values of a system in which the magneto-inductive flowmeter is to be used can be tested for plausibility. With this, inter alia, a defective sensor, in particular a voltage sensor, can be identified. Equally, a sensor with signs of degradation can be identified. The invention is also, inter alia, based on the surprising discovery that the methods outlined above can be modeled with enhanced precision using a relatively small computational effort. Accordingly, using the computer program product in accordance with the invention, an extensive and simultaneously computation capacity-saving possibility for monitoring and/or testing a corresponding magneto-inductive flowmeter can be made available. The computer program product can be formed as a so-called digital twin, as described in greater detail in the publication US 2017/286572 A1. The disclosure content of US 2017/286572 A1 is incorporated herein by reference in its entirety. Furthermore, the computer program product can be formed in a monolithic manner, i.e., it can implement all its functions on one hardware platform. Alternatively, the computer program product can also be structured modularly and can comprise a plurality of partial programs that can be executed on separate hardware platforms and cooperate via a communicative data connection. In particular, the computer program product can be executed in a computer cloud. Furthermore, via the computer program product in accordance with the invention, a magneto-inductive flowmeter can be tested and/or optimized through simulation, for example, for a planned retrofit in a system.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will now be described in greater detail by reference to individual exemplary embodiments in the figures.

The figures are to be considered as mutually complementary to the extent that the same reference characters in the different figures have the same technical meaning. The features of the individual embodiments are also capable of being combined with one another. Furthermore, the embodiments shown in the figures are capable of being combined with the features outlined above, in which:

FIG. 1 shows a schematic representation of an embodiment of the magneto-inductive flowmeter in accordance with the invention;

FIG. 2 shows a stage of an embodiment of a first method in accordance with the invention;

FIG. 3 shows a subsequent stage of the method of FIG. 2;

FIG. 4 shows a further stage of the method of FIG. 3;

FIG. 5 shows schematically a sequence of a second method in accordance with the invention;

FIG. 6 is a flowchart of the method in accordance with a first embodiment; and

FIG. 7 is a flowchart of the method in accordance with a second embodiment.

### DETAILED DESCRIPTION OF THE EXEMPLARY EMBODIMENTS

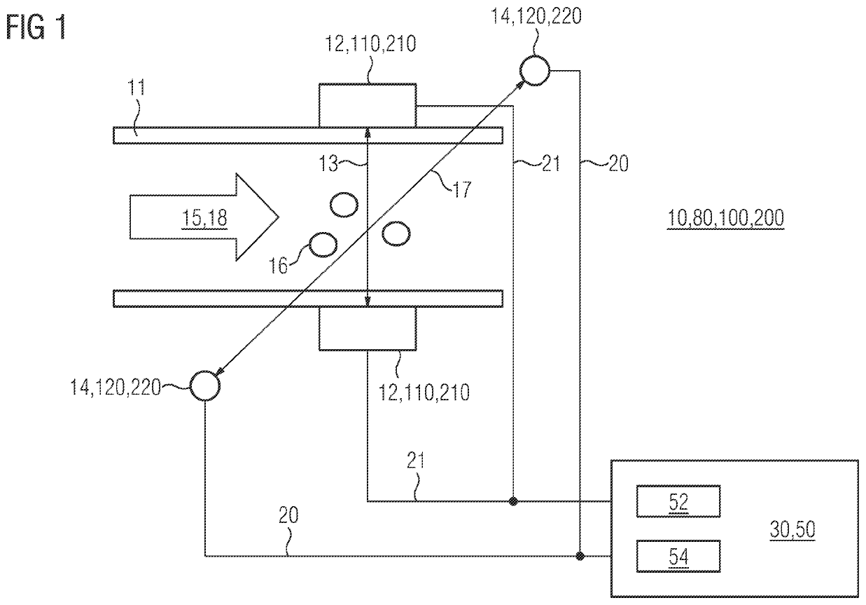

A schematic configuration of an embodiment of a magneto-inductive flowmeter 10 in accordance with the invention is shown in FIG. 1. The magneto-inductive flowmeter 10 is mounted on a pipe 11 and is configured to measure a flow rate 15 through the pipe 11. For this purpose, the magneto-inductive flowmeter 10 has magnet coils 12 that are excitable via a control unit 30. For this purpose, the control unit 30 is configured for excitation, to send excitation signals in the form of square-wave signals 21 to the magnet coils 12. With the magnet coils 12, a changeable magnetic field 13 can be created with a pulse frequency 19 with which electrically charged particles 16 in the fluid 18, the flow rate 15 of which is to be measured, enter into interaction. The interaction between the electrically charged particles 16 and the magnetic field 13 consists in a causation of an electrical voltage 17 substantially transversely to the magnetic field 13, which can be captured via voltage sensors 14. The electric voltages 17 captured can be passed on as measurement signals 20 to the control unit 30. The excitation of the magnet coils 12 occurs via the square-wave signal 21 so that the magnetic field 13 has a specifiable magnetic flux density substantially immediately, sustains it for a specifiable pulse duration and subsequently returns to zero again substantially immediately. Such a square-wave signal 21 configured as a square-wave signal is also designated a boxcar signal. The excitation of the magnet coil 12 herein occurs in a first step 110, 210 of a method 100, 200 in order to measure the flow rate 15. The capturing of the electric voltage 17 via the voltage sensors 14 occurs in a second step 120, 220. The respective first steps 110, 210 are identical in all the methods 100, 200 in accordance with the invention. The methods 100, 200 that can be performed with the control unit 30 are based upon the same consideration of the behavior of the captured measurement signals 20 that reflect the created voltage 17. The control unit 30 has a storage unit 52 and a computing unit 54 via which a computer program product 50 can be executed, via which the at least one of the methods 100, 200 can be implemented. Furthermore, the magneto-inductive flowmeter 10 is mapped in a computer program product 80 which is designed as a “digital twin”. This is at least suitable, preferably configured, to simulate the operating behavior of the magneto-inductive flowmeter 10 and, for this purpose, comprises a structural map of the magneto-inductive flowmeter 10 and/or a mathematical model which reflects the functional method thereof. The computer program product 80 for simulating the operating behavior permits, for example, a defective magnet coil 12 or a defective voltage sensor 14 to be identified and/or an established flow rate 15 to be made plausible.

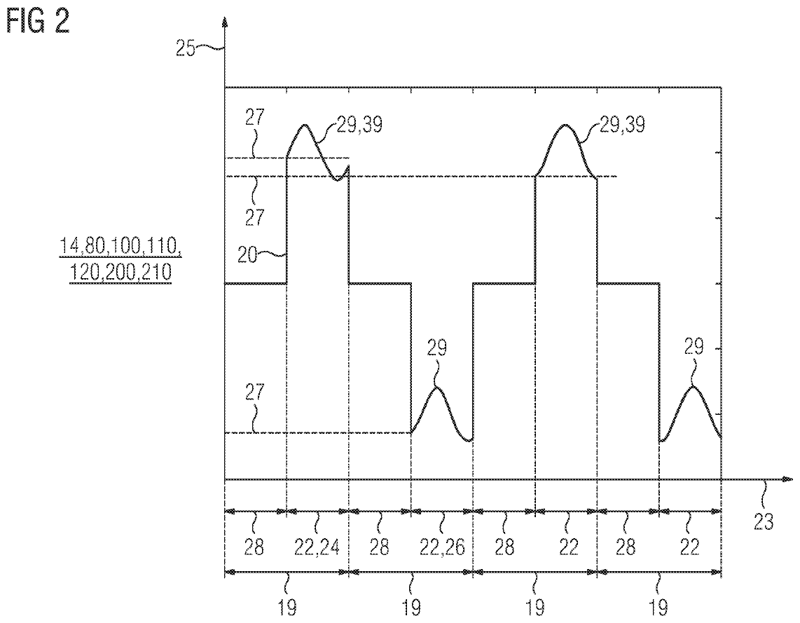

One embodiment of the first method 100 according to the invention is mapped schematically in one stage in FIG. 1. FIG. 1 shows a graphical diagram with a horizontal time axis 23 and a vertical voltage axis 25 as the variable axis. The graph shows a variation of a measurement signal 20 that corresponds to a voltage 17 captured via voltage sensors 14, as for example, illustrated in FIG. 1. The measurement signal 20 corresponds in its basic form to a square-wave signal 21 with which magnet coils 12, as in FIG. 1, are excited. The measurement signal 20 comprises measurement value portions 22 that follow one another with alternating orientations. Between the measurement value portions 22, there are inactive phases 28 the duration of which, i.e., their extent along the time axis 23, are adjustable. The respective durations of the measurement value portions 22, i.e., their extent along the time axis 23, are adjustable. The durations of the measurement value portions 22 and of the inactive phases 28 together result in period durations that correspond to the pulse frequency 19 with which the changeable magnetic field 13 in the pipe 11 is evoked by the magnet coils 12. Each measurement value portion 22 has an amplitude value 27 that corresponds to the voltage 17 that is reproduced by the measurement signal 20. The amplitude value 27 that corresponds to the existing voltage 17 has impressed upon it in the measurement signal 20 an interference 29 that has an interference frequency 39. As a result of the interference 29, the recognition of the correct amplitude value 27 is made more difficult. The graphical plot of FIG. 2 shows a stage of the first method 100 in which the first and second step 110, 120 is already performed and a further evaluation of the measurement signal 20 is to be performed. For the further evaluation of the measurement signal 20, individual measurement value portions 22, in particular a first and a second measurement value portion 24, 26 is examined more closely. The stage of the method 100 shown in FIG. 2 is simulated in a computer program product 80 that is formed as a digital twin.

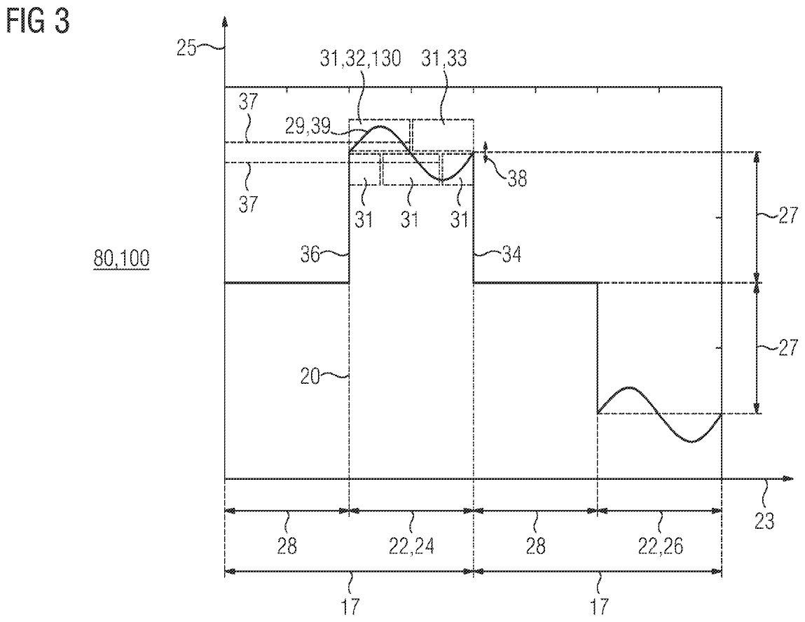

In FIG. 3, a stage of the first method 100 in accordance with the invention, which adjoins the stage represented in FIG. 2, is shown. FIG. 3 essentially shows an enlarged portion of the graphical plot of FIG. 2. Correspondingly, the graph in FIG. 3 also has a time axis 23 and a voltage axis 25 in which the shape of the measurement signal 20 is represented. In a third step 130, a first measurement value portion 24 to be evaluated more closely is identified. The first measurement value portion 24 is easily recognizable from the signal technology viewpoint, for example, based on its substantially vertical front flank 34 and/or rear flank 34. In the third step 130, the first measurement value portion 24 is subdivided into sub-portions 31 that are to be investigated separately. For a first sub-portion 32 of the first measurement value portion 24, in the third step 130, a mean value 37 of the measurement signal 20 is established. Equally, in the third step 130, a mean value 37 is established for a second sub-portion 33 of the first measurement value portion 24. The mean values 37 are indicated in FIG. 3 with broken lines. The second sub-portion 33 herein follows directly after the first sub-portion 32. Due to the substantially sinusoidal interference 29, the mean values 37 of the measurement signal 20, i.e., its respective mean amplitude value 27 in the first and second sub-portion 32, 33 are unequal. With an equalization of the mean values 37 in the first and second sub-portions 32, 33, for example, via suitable difference formation, it is possible to establish that the interference 29 is present. The presence of the interference 29 is recognized if the mean values 37 in the first and second sub-portion 32, 33 differ from one another by at least an interference threshold value 38. The interference threshold value 38 is specified by a user or an algorithm that can be configured as a component of the computer program product 50 in the control unit 30. Alternatively or additionally, as the first and/or second sub-portion 32, 33, other sub-portions 31 that can also partially overlap temporally are also capable of selection. With repeated execution of the third step 130 with differently selected sub-portions 31 as the first and second sub-portion 32, 33 of the first measurement value portion 24, the form of the interference 29 can also able be determined more closely. Further alternatively or additionally, the third step 130 can also be correspondingly performed on a second measurement value portion 26. The formation of the mean value 37 can be performed rapidly in a simple manner and represents an expressive parameter for the method 100. The stage of the method 100 shown in FIG. 3 is simulated in a computer program product 80 which is formed as a digital twin.

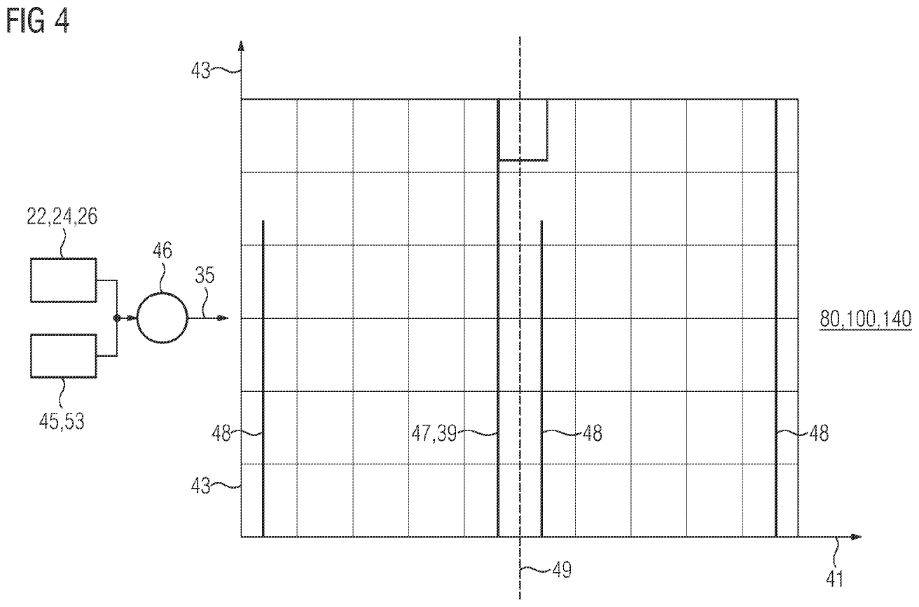

A further stage of the first method 100 in accordance with the invention is mapped in FIG. 4. The stage in FIG. 4 proceeds therefrom that at least the first and second step 110, 120 are completed and a fourth step 140 can be performed. For the fourth step 140, a carrier signal 45 is provided. The captured measurement signal 20, as shown, for example, in FIG. 2 is combined with the carrier signal 45 at least in the context of the first and second measurement value portion 24, 26 in the course of a modulation 46. The modulation 46 is formed as a quadrature amplitude modulation. The modulated carrier signal 35 obtained in this way is further subjected to a frequency analysis in the course of the fourth step 140 of a frequency analysis 40, the result of which is shown in FIG. 4 as a graphical plot. The graph comprises a horizontal frequency axis 41 and a vertical magnitude axis 43. Furthermore, the graph is divided by a line that represents the “zero frequency”, which serves as a comparison frequency 49. In the case of a measurement signal 20 that is free of interferences 29 or in which the interferences are suppressed, in the frequency analysis 40, a spike, also called a peak, in the comparison frequency 49 is to be expected. In the fourth step 140, as shown in FIG. 4, a frequency shift 47 that quantifies the interference 29 is recognized. The amount of the frequency shift 47, i.e., its spacing from the comparison frequency 49, corresponds to the interference frequency 39, as is shown, by way of example, in FIG. 2 or FIG. 3. A recognition of artifacts 48 in the frequency analysis 40 also occurs so that a confusion with an interference frequency 39, i.e., an interference 29 is avoided. The artifacts 48 can be predicted computationally by the computer program product 50 in the control unit 30 based on details concerning the carrier frequency 53 in conjunction with information regarding the pulse frequency 19. With this, avoidance of inappropriately diagnosed interferences 29 is ensured in a simple manner. Starting from the interference 29 quantified in the fourth step 140 via the interference frequency 39, a cause of the interference 29 can be deduced. Furthermore, the duration of the inactive phases 28 and/or measurement value portions 22, as shown in FIG. 2 or FIG. 3, is adaptable so that the interference effect of the interference 29 for the establishment of the flow rate 15 is minimized. The method 100, as mapped in FIG. 4, enables altogether a reliable and sufficiently exact quantification of the existing interference 29 so that countermeasures can be introduced in a targeted manner. The method 100 is thus independently adaptable and consequently robust against interferences 29. The stage of the method 100 shown in FIG. 4 is simulated in a computer program product 80 which is formed as a digital twin.

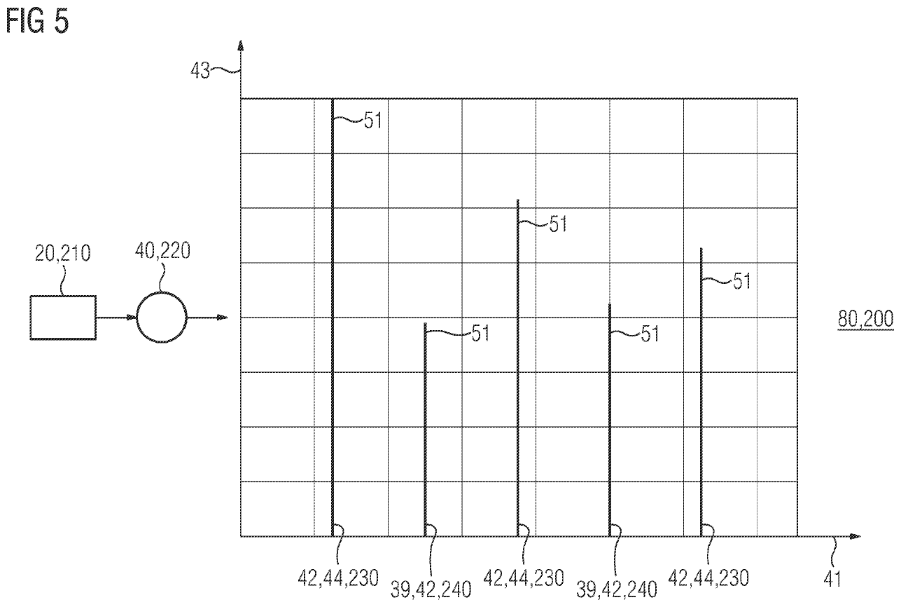

An embodiment of a second method 200 in accordance with the invention for measuring a flow rate 15 in a pipe 11 is shown schematically in FIG. 5. The method 200 assumes that a first step 210, as shown in FIG. 2, has already been performed. Accordingly, a measurement signal 20 from the first step 210 is available that is processed in a second step 220 for which a frequency analysis 40 is performed. The frequency analysis 40 is herein implemented as a Fourier analysis via which the frequency components 42 of the measurement signal 20 are captured. The result of the frequency analysis 40 is represented in FIG. 5 in a graphical plot that has a horizontal frequency axis 41 and a vertical magnitude axis 43. The frequency analysis 40 shows a plurality of frequency components 42, the frequency of each of which is captured in a third step 230. Under the frequency components 42, square-wave frequency components 44 are recognized because they correspond, as far as frequency is concerned, i.e., the position of the respective peak 51 on the frequency axis 41, substantially to an odd multiple of the pulse frequency 19 with which, as outlined in FIG. 2, the varying magnetic field 13 is produced. The method 200 is based on the fact that, in a Fourier analysis, a square-wave signal 21 exclusively has frequency components 42 that correspond to odd multiples of the pulse frequencies 19. Such frequency components 42 are consequently reliably recognizable in the method 200. Further frequency components 42 that lie between the square-wave frequency components 44 are recognized in a fourth step 240 as interference frequencies 39. Herein, even-numbered harmonics indicate non-linearities that are coupled to the pulse signal 19. For example, this can be saturation effects in magnetic materials or electrochemical effects. Signal components with other frequencies can indicate external interferences or defects in the electronics of the device. Based on the result of the third and fourth step 230, 240, it is easy to identify which frequency components 42 of the measurement signal 20 are to be utilized for an establishment of the flow rate 15 in the pipe 11, as shown in FIG. 1. For example, the interference frequencies 39 recognized in the method 200 can be removed via a suitable filter. Alternatively or additionally, an amplitude value 27 can be established from the square-wave frequency components 44, as outlined for example in FIG. 2. Frequency analyses 40, in particular Fourier analyses, can be implemented rapidly and precisely in a large number of control units 30 for magneto-inductive flowmeters 10. The increasingly available computational power of control units 30 is thereby utilized and becomes possible to use magneto-inductive flowmeters 10 in demanding environments. The method 200 can therefore be implemented device-bound, i.e., in a decentralized manner. Higher-order control systems of automation systems are thus relieved with regard to computation effort for flow measurement. This makes it possible to use a large number of magneto-inductive flowmeters 10 in an automation system without running the risk that they generate an escalating checking and correcting workload in the higher-level control system with inappropriate values for the flow rate 15 that is to be measured. Consequently, the method 200 enables magneto-inductive flowmeters 10 with which complex automation systems can also be operated in a practicable manner. The method 200 as outlined in FIG. 5 can also be simulated in a computer program product 80 which is formed as a digital twin.

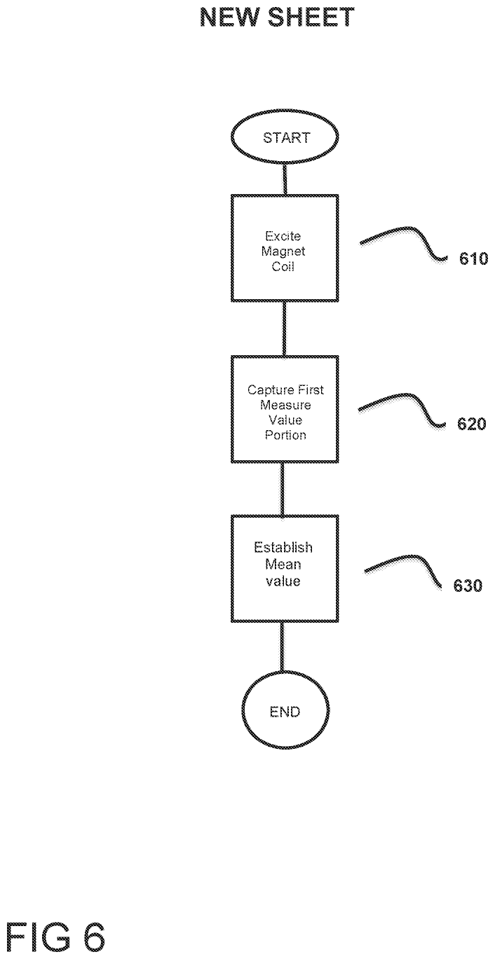

FIG. 6 is a flowchart of the method 100 for measuring a flow rate 15 in a pipe 11 via a magneto-inductive flowmeter 10 fastened to the pipe 11. The method comprises a) exciting a magnet coil 12 of the magneto inductive flowmeter 10 with a square wave signal 21 at a pulse frequency 19 and capturing a measurement signal 20, as indicated in step 610.

Next, b) a first measurement value portion 24 of the measurement signal 20 is captured, as indicated in step 620. Here, measurement value portion comprises a first and a second sub-portion 32, 33.

Next, c) a mean value 37 of the measurement signal 20 in each of the first and second sub portions 32, 33 is established, as indicated in step 630.

In accordance with the method, an interference 29 of the measurement signal 20 is recognized if the mean values 37 differ from one another by at least an adjustable interference threshold value 38. In addition, the square-wave signal 21 has an inactive phase 28 that is adjustable independently of at least one of the first and second measurement value portion 24, 26, and in a further step, at least one of a pulse duration of the square-wave signal 21 and a duration of the inactive phase 28 is adapted to balance an interference effect in successive measurement value portions 22, 24, 26.

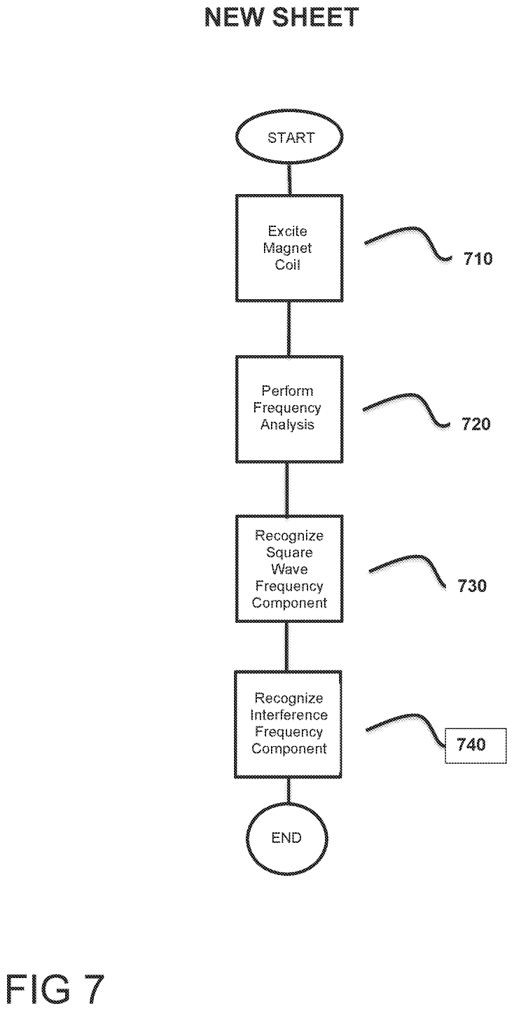

FIG. 7 is a flowchart of a method 200 for measuring a flow rate 15 in a pipe 11 via a magneto-inductive flowmeter 10 fastened to the pipe 11. The method comprises a) exciting a magnet coil 12 of the magneto inductive flowmeter 10 with a square wave signal 21 at a pulse frequency 19 and capturing a measurement signal 20, as indicated in step 710.

Next, b) a frequency analysis 40 of the measurement signal 20 is performed to establish frequency components 42 of the measurement signal 20, as indicated in step 720.

Next, c) a frequency component 42 of the measurement signal 20 is recognized as a square-wave frequency component 44 if the frequency component 42 corresponds to an odd-numbered fraction of the pulse frequency 19 or otherwise d) a frequency component of the measurement signal 20 is recognized as an interference frequency 39, as indicated in step 730.

In accordance with the invention, in a further step, durations of measurement value portions 22 are amended to an integer multiple of a period duration of the interference frequency 39, and durations of inactive phases 28 are adapted.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-14. (canceled)

15. A method for measuring a flow rate in a pipe via a magneto-inductive flowmeter fastened to the pipe, the method comprising:
a) exciting a magnet coil of the magneto-inductive flowmeter with a square-wave signal at a pulse frequency and capturing a measurement signal;
b) capturing a first measurement value portion of the measurement signal, said measurement value portion comprising a first and a second sub-portion; and
c) establishing a mean value of the measurement signal in each of the first and second sub-portions;
wherein an interference of the measurement signal is recognized if the mean values differ from one another by at least an adjustable interference threshold value; and
wherein the square-wave signal has an inactive phase which is adjustable independently of at least one of the first and second measurement value portion, and in a further step, at least one of a pulse duration of the square-wave signal and a duration of the inactive phase is adapted to balance an interference effect in successive measurement value portions.

16. The method as claimed in claim 15, wherein the first and second sub-portions follow one another temporally or partially overlap temporally.

17. The method as claimed in claim 15, wherein a mean value of the measurement signal is established for each of the first measurement value portion and a second measurement value portion, an amplitude of the measurement signal being established based on the established mean value.

18. The method as claimed in claim 16, wherein a mean value of the measurement signal is established for each of the first measurement value portion and a second measurement value portion, an amplitude of the measurement signal being established based on the established mean value.

19. The method as claimed in claim 15, wherein at least said steps a) and b) are also performed for the second measurement value portion; and wherein the measurement signals of the first and second measurement value portions are modulated onto a carrier signal having a carrier frequency which corresponds to the pulse frequency, and from this a frequency shift relative to a comparison frequency is established.

20. The method as claimed in claim 16, wherein at least said steps a) and b) are also performed for the second measurement value portion; and wherein the measurement signals of the first and second measurement value portions are modulated onto a carrier signal having a carrier frequency which corresponds to the pulse frequency, and from this a frequency shift relative to a comparison frequency is established.

21. The method as claimed in claim 17, wherein at least said steps a) and b) are also performed for the second measurement value portion; and wherein the measurement signals of the first and second measurement value portions are modulated onto a carrier signal having a carrier frequency which corresponds to the pulse frequency, and from this a frequency shift relative to a comparison frequency is established.

22. The method as claimed in claim 19, wherein the modulation onto the carrier signal occurs via at least one of a quadrature amplitude modulation and the comparison frequency is a mains target frequency.

23. A method for measuring a flow rate in a pipe via a magneto-inductive flowmeter fastened to the pipe, the method comprising:
a) exciting a magnet coil of the magneto-inductive flowmeter with a square-wave signal at a pulse frequency and capturing a measurement signal;
b) performing a frequency analysis of the measurement signal to establish frequency components of the measurement signal;
c) recognizing a frequency component of the measurement signal as a square-wave frequency component if the frequency component corresponds to an odd-numbered fraction of the pulse frequency; and otherwise
d) recognizing a frequency component of the measurement signal as an interference frequency;
wherein in a further step, durations of measurement value portions are amended to an integer multiple of a period duration of the interference frequency; and
wherein durations of inactive phases are adapted.

24. The method as claimed in claim 23, wherein the frequency analysis is implemented as a Fourier analysis or a wavelet analysis.

25. The method as claimed in claim 23, wherein a further step e) is carried out in which an amplitude of the measurement signal is established on the basis of the frequency analysis.

26. A control unit of a magneto-inductive flowmeter, comprising:
a storage unit; and
a computer unit for executing a computer program product;
wherein the control unit is configured to:
a) excite a magnet coil of the magneto-inductive flowmeter with a square-wave signal at a pulse frequency and capturing a measurement signal;
b) capture a first measurement value portion of the measurement signal, said measurement value portion comprising a first and a second sub-portion; and
c) establish a mean value of the measurement signal in each of the first and second sub-portions;
wherein an interference of the measurement signal is recognized if the mean values differ from one another by at least an adjustable interference threshold value; and
wherein the square-wave signal has an inactive phase which is adjustable independently of at least one of the first and second measurement value portion, and in a further step, at least one of a pulse duration of the square-wave signal and a duration of the inactive phase is adapted to balance an interference effect in successive measurement value portions.

27. A control unit of a magneto-inductive flowmeter, comprising:
a storage unit; and
a computer unit for executing a computer program product;
wherein the control unit is configured to:
a) excite a magnet coil of the magneto-inductive flowmeter with a square-wave signal at a pulse frequency and capturing a measurement signal;
b) perform a frequency analysis of the measurement signal to establish frequency components of the measurement signal;
c) recognize a frequency component of the measurement signal as a square-wave frequency component if the frequency component corresponds to an odd-numbered fraction of the pulse frequency; and otherwise
d) recognize a frequency component of the measurement signal as an interference frequency;
wherein in a further step, durations of measurement value portions are amended to an integer multiple of a period duration of the interference frequency; and
wherein durations of inactive phases are adapted.

28. A magneto-inductive flowmeter for measuring a flow rate through a pipe, comprising a magnet coil and a voltage sensor which are connected to a control unit, wherein the control unit is configured as claimed in claim 27.

29. A computer program product which is configured for simulating an operating behavior of a magneto-inductive flowmeter, wherein the flow meter is configured as claimed in claim 28 and the computer program product is formed as a digital twin.

30. The computer program product as claimed in claim 29, wherein the computer program product has a physics module; wherein the magneto-inductive flowmeter is mapped and the electrical or signaling behavior thereof is emulatable under adjustable operating conditions; wherein the adjustable operating conditions include an interference spectrum with different interference frequencies, and the computer program product is configured to test measurement signals of voltage sensors of the magneto-inductive flowmeter for plausibility to identify a defective voltage sensor.
